(19) United States
(12) Patent Application Publication
(10) Pub. No.: US 2026/0109618 A1
(43) Pub. Date: Apr. 23, 2026

(54) SnS DISPERSION LIQUID AND METHOD FOR PRODUCING SAME

(71) Applicant: CHALCOGENIC CO., LTD., Nishitama-gun, Tokyo (JP)

(72) Inventors: Shigeo Nishimura, Hamura-shi (JP); Yoshitaro Nose, Hamura-shi (JP)

(73) Assignee: CHALCOGENIC CO., LTD., Nishitama-gun, Tokyo (JP)

(21) Appl. No.: 19/486,597

(22) PCT Filed: May 22, 2024
(86) PCT No.: PCT/JP2024/018848

§ 371 Date: Nov. 21, 2025

(30) Foreign Application Priority Data
May 25, 2023 (JP) 2023-086547

(51) Int. Cl. C01G 19/00

(52) U.S. Cl. CPC C01G 19/00; C01P 2002/72; C01P 2002/90; C01P 2004/03; C01P 2004/51; C01P 2004/54; C01P 2006/12

(57) ABSTRACT

A SnS dispersion liquid has SnS particles dispersed in a water-based or alcohol-based dispersion liquid, in which the average major axis of the dispersed SnS particles is 100-2000 nm, the average minor axis of the SnS particles is 50-1000 nm, and the average aspect ratio (major axis/minor axis) is 1.2-1.6. A method for producing an SnS dispersion liquid comprises: a vapor deposition step for heating an SnS raw material housed in an evaporation source container and capturing SnS in a capturing container; an isolation step for separating an obtained vapor deposition product from the capturing container to obtain SnS particles; and a dispersion step for dispersing the vapor deposition product obtained in the isolation step in a water-based dispersion liquid. In the vapor deposition step, the heating temperature of the evaporation source container is 700-900° C., and the maximum capturing container temperature of the capturing container is 80-130° C.

### TECHNICAL FIELD

The present invention relates to a SnS dispersion liquid and a method for producing the same, and more specifically to a SnS dispersion liquid and SnS particles that have good dispersibility and show no precipitation during storage, as well as to a method for producing the SnS particles and a method for producing the SnS dispersion liquid.

### BACKGROUND ART

Metal sulfides have attracted attention in various fields, such as energy-related field and lubricant field, and stannous sulfide (SnS) has attracted attention because of its particularly excellent properties. For this reason, various metal sulfides containing stannous sulfide with adjusted particle size, etc. and methods for producing the same have been proposed. For example, PTL 1 proposes a method for producing a tin sulfide film with crystals oriented in a specific direction by a vacuum plating method. Specifically, a method for producing a tin sulfide film has been proposed in which a tin sulfide film is formed on a substrate surface by vacuum plating at a vacuum degree in the range of 133.3×10⁻⁴ to 13.3×10⁻⁷ Pa, the method being characterized in that the substrate temperature is controlled in the range of 120° C. to 400° C. and the film formation rate is controlled in the range of 0.05 μm/min to 0.5 μm/min, and the tin sulfide film crystals are oriented in a specific direction. PTL 2 proposes a tin sulfide production method that is industrially simple and safe, does not use special equipment such as high-pressure equipment or harmful substances such as mercury, and can prevent contamination of the reaction system by unreacted sulfur. Specifically, a tin sulfide production method has been proposed in which an object to be treated that contains metallic tin and sulfur and has a molar ratio (S/Sn), on atomic basis, of sulfur content to metallic tin content of 1 to 4 is subjected to a mechanochemical treatment to react the metallic tin with the sulfur to obtain tin sulfide. PTL 3 proposes a method for producing powder containing stannous sulfide, the method having good energy efficiency and production efficiency and being suitable for continuous production. Specifically, the proposed production method includes a charging step of introducing tin powder and sulfur powder or lumps, in which the ratio of the number of sulfur atoms to the number of tin atoms (S/Sn) is 0.95 or more and 1.50 or less, into a mill, and a treatment step of operating the mill to mechanically activate the tin and sulfur and causing a chain synthesis reaction due to the heat of the synthesis reaction of tin and sulfur, wherein the charging step is carried out at a temperature inside the mill lower than the melting point of sulfur. PTL 4 proposes a production method for obtaining a high-purity chalcogenide compound with about 1:1 ratio of Group 14 and Group 16 elements of the periodic table, which was previously difficult, and specifically, proposes a high-purity chalcogenide material and a method for producing the same, the material containing a chalcogenide compound represented by the general formula: M¹M²ₓ [wherein M¹ represents an element of Group 14 of the periodic table, M² represents an element of Group 16 of the periodic table, and x is 0.9 to 1.1] and having the amount of the chalcogenide compound present of 90 mol % or more in an X-ray diffraction measurement.

### CITATION LIST

### Patent Literature

PTL 1: Japanese Patent Application Publication No. H08-144044
PTL 2: Japanese Patent Application Publication No. 2015-120607
PTL 3: Japanese Patent Application Publication No. 2018-5278
PTL 4: WO 2020/013191

### SUMMARY OF INVENTION

### Technical Problem

However, the tin sulfides according to the abovementioned proposals and the tin sulfides obtained by the proposed production methods have not yet achieved the required performance. As a result of extensive investigation of the reasons why the previously proposed tin sulfides could not achieve the desired performance, the present inventors have found that one of the reasons is poor dispersibility in the dispersion liquid, which represents the state before the tin sulfide is used. That is, obtaining tin sulfide with good dispersibility is important for achieving the desired performance, and a dispersion liquid of tin sulfide with good dispersibility and no precipitation during storage is required.

Therefore, an object of the present invention is to provide a dispersion liquid of SnS particles with good dispersibility and no precipitation during storage, SnS particles, a method for producing the SnS dispersion liquid, and a method for producing the SnS particles.

### Solution to Problem

As a result of intensive research aimed at the solution of the above problem, the present inventors found that the above object can be achieved by obtaining a dispersion liquid having dispersed therein SnS particles produced by performing a vapor deposition step under specific temperature conditions, and this finding led to the completion of the present invention. That is, the present invention provides the following inventions.
1. A SnS dispersion liquid in which SnS particles are dispersed in a water-based or alcohol-based dispersion liquid, wherein an average major axis of the dispersed SnS particles is 100 nm to 2000 nm, an average minor axis of the SnS particles is 50 nm to 1000 nm, and an average aspect ratio (major axis/minor axis) is 1.2 to 1.6. 2. The SnS dispersion liquid according to 1, wherein a concentration of the SnS particles in the water-based dispersion liquid is 0.0001% by mass to 50% by mass. 3. The SnS dispersion liquid according to 1, wherein an average thickness of the SnS particles is 100 nm to 1000 nm, and a particle size distribution (based on scattering intensity, D50) of the SnS particles is in the range of 100 nm to 700 nm. 4. The SnS dispersion liquid according to 1, wherein a SnS purity as measured by XRD of dried SnS particles is 90% by mass or more. 5. The SnS dispersion liquid according to 1, wherein a specific surface area of the SnS particles is 5 m²/g or more as measured by a BET measurement method. 6. The SnS dispersion liquid according to 1, wherein a mass absorption coefficient (0.001% by mass) is 15,000 cm⁻¹ or more at a wavelength of 600 nm. 7. SnS particles extracted from the SnS dispersion liquid according to 1, wherein an average major axis of the SnS particles is 100 nm to 2000 nm, an average minor axis of the SnS particles is 50 nm to 1000 nm, and an average aspect ratio (major axis/minor axis) is 1.2 to 1.6. 8. The SnS particles according to 7, wherein an average thickness of the SnS particles is 100 nm to 1,000 nm, and a particle size distribution (based on scattering intensity, D50) of the SnS particles is in the range of 100 nm to 700 nm. 9. The SnS particles according to 7, wherein a SnS purity as measured by XRD of dried SnS particles is 90% by mass or more. 10. The SnS particles according to 7, wherein a specific surface area of the SnS particles is 5 m²/g or more as measured by a BET measurement method.
11, The SnS particles according to 7, wherein the SnS particles are mixed particles of SnS and acetylene black including acetylene black in addition to SnS.
12. A method for producing SnS particles, including: a vapor deposition step of heating a SnS raw material contained in an evaporation source container to capture SnS in a capture container, and an isolation step of separating the obtained vapor deposition product from the capture container to obtain SnS particles, wherein in the vapor deposition step, a heating temperature of the evaporation source container is 700° C. to 900° C. and a maximum capture container temperature of the capture container is 80° C. to 130° C. 13. The method for producing SnS particles according to 12, wherein an average capture rate in the vapor deposition step is 20 mg/min or more. 14. A method for producing the SnS dispersion liquid according to 1, including: a vapor deposition step of heating a SnS raw material contained in an evaporation source container to capture SnS in a capture container, an isolation step of separating the obtained vapor deposition product from the capture container to obtain SnS particles, and a dispersion step of dispersing the vapor deposition product obtained in the isolation step in a water-based or alcohol-based dispersion liquid, wherein in the vapor deposition step, a heating temperature of the evaporation source container is 700° C. to 900° C. and a maximum capture container temperature of the capture container is 80° C. to 130° C. 15. The method for producing the SnS dispersion liquid according to 14, wherein the dispersion step includes an ultrasonic dispersion step of performing ultrasonic dispersion with an amplitude of 50 μm to 150 μm.

### Advantageous Effects of Invention

The SnS dispersion liquid of the present invention has good dispersibility with no precipitation during storage.

The SnS particles of the present invention constitute the SnS dispersion liquid of the present invention and can exhibit excellent characteristics. Furthermore, according to the method for producing an SnS dispersion liquid of the present invention, it is possible to produce a dispersion liquid of SnS particles that has good dispersibility with no precipitation during storage. According to the method for producing SnS particles of the present invention, it is possible to obtain SnS particles that constitute the abovementioned SnS dispersion liquid, which can exhibit excellent properties. Since the SnS particles obtained from the SnS dispersion liquid of the present invention can exhibit excellent properties, they are useful as a raw material in the energy-related field, lubricant field, etc.

### BRIEF DESCRIPTION OF DRAWINGS

FIG. 1 is a schematic diagram showing a vapor deposition apparatus for carrying out a vapor deposition step in the method for producing SnS dispersion liquid of the present invention.

FIG. 2 is a SEM photograph (a photograph replacing a drawing) showing the particle state of SnS particles dispersed in the SnS dispersion liquid obtained in Example 1.

FIG. 3 is a SEM photograph (a photograph replacing a drawing) showing the particle state of SnS particles dispersed in the SnS dispersion liquid obtained in Example 2.

FIG. 4 is a SEM photograph (a photograph replacing a drawing) showing the particle state of SnS particles dispersed in the SnS dispersion liquid obtained in Example 3.

FIG. 5 is a photograph replacing a drawing that shows the dispersion state of a SnS dispersion liquid, (a) shows the initial state of the SnS dispersion liquid obtained in Example 1, (b) shows the state of the SnS dispersion liquid obtained in Example 1 after 17 h, (c) shows the initial state of the SnS dispersion liquid obtained in Example 2, (d) shows the state of the SnS dispersion liquid obtained in Example 2 after 17 h, (e) shows the initial state of the SnS dispersion liquid obtained in Example 3, (f) shows the state of the SnS dispersion liquid obtained in Example 3 after 17 h, (g) shows the initial state of the SnS dispersion liquid obtained in Comparative Example, and (h) shows the state of the SnS dispersion liquid obtained in Comparative Example after 17 h.

FIG. 6 is a SEM photograph (a photograph replacing a drawing) showing the particle state of SnS particles dispersed in the SnS dispersion liquid obtained in Comparative Example.

FIG. 7 is a chart showing the XRD measurement results of the SnS particles obtained in Examples and Comparative Example.

FIG. 8 is a photograph replacing a drawing that shows the dispersion state of SnS dispersion liquid, (a) shows the initial state of the SnS dispersion liquid obtained in Example 4, (b) shows the initial state of the SnS dispersion liquid obtained in Example 5, (c) shows the initial state of the SnS dispersion liquid obtained in Example 6, (d) shows the initial state of the SnS-acetylene black dispersion liquid obtained in Example 7, (e) shows the tin sulfide-acetylene black mixed particles obtained in Example 7, (f) shows the initial state of the dispersion liquid obtained by redispersing the particles obtained in Example 7 in water, (g) shows the initial state of the SnS-acetylene black dispersion liquid obtained in Example 8, (h) shows the tin sulfide-acetylene black mixed particles obtained in Example 9, and (i) shows the initial state of the dispersion liquid obtained by redispersing the particles obtained in Example 8 in water.

FIG. 9 is a chart showing the particle size distribution of the SnS particles or SnS-acetylene black particles obtained in Examples 4 to 8.

FIGS. 10(a) to 10(d) are SEM photographs (photographs replacing drawings) showing the particle state of SnS-acetylene black particles dispersed in the SnS dispersion liquids obtained in Examples 7 and 8, respectively.

### DESCRIPTION OF EMBODIMENTS

The present invention will be described in more detail below. <SnS Dispersion Liquid and SnS Particles> The SnS dispersion liquid of the present invention is a SnS dispersion liquid in which SnS particles are dispersed in a water-based or alcohol-based dispersion liquid, and the average particle diameter (average of major axes) and average aspect ratio (major axis/minor axis) of the dispersed SnS particles are in specific ranges. Furthermore, the SnS particles of the present invention are obtained from the SnS dispersion liquid of the present invention, and the average particle diameter (average of major axes) and average aspect ratio (major axis/minor axis) thereof are in specific ranges. The SnS particles of the present invention are extracted (taken out) from the SnS particles constituting the abovementioned SnS dispersion liquid and dried.

[SnS Particles (SnS Particles of the Present Invention)] In the present invention, the SnS particles (SnS particles of the present invention) dispersed in the SnS dispersion liquid have an average major axis of 100 nm to 2000 nm, preferably 100 nm to 500 nm, and most preferably 100 nm to 200 nm. Also, the average minor axis is 50 nm to 1000 nm, preferably 50 nm to 200 nm, and most preferably 50 nm to 150 nm. The average aspect ratio (major axis/minor axis) is 1.2 to 1.6. Measurement methods for these are described in detail in the Examples, but all of them can be measured using the SnS dispersion liquid. In other words, the SnS particles of the present invention can be said to be particles for which the average major axis, average minor axis and average aspect ratio measured in the SnS dispersion liquid are within the above ranges. It is considered that as a result of the average major axis, the average minor axis and the average aspect ratio being within the above ranges, the dispersibility in the dispersion liquid is improved, and in turn various types of performance of the SnS particles themselves are improved to the required level. The average major axis is the average value of the diameters of the longest parts of the particles, and the average minor axis is the average value of the diameters of the shortest parts of the particles. Further, the average thickness of the SnS particles is preferably 100 nm to 1000 nm, and more preferably 100 nm to 300 nm. The particle size distribution (based on scattering intensity, D10) of the SnS particles is preferably in the range of 100 nm to 200 nm. The particle size distribution (based on scattering intensity, D50) of the SnS particles is preferably in the range of 100 nm to 700 nm, more preferably 200 nm to 500 nm. The particle size distribution (based on scattering intensity, D90) of the SnS particles is preferably in the range of 500 nm to 1500 nm. When the average thickness and the particle size distribution (particularly D50) are within the above ranges, dispersibility is further improved and the required performance is improved.

From the viewpoint of improving dispersibility, the specific surface area of the SnS particles is preferably 5 m²/g or more, more preferably 5 m²/g to 20 m²/g, and most preferably 8 m²/g to 15 m²/g, as measured by the BET method. The SnS particles of the present invention can be obtained by drying SnS particles dispersed in the SnS dispersion liquid. The obtained dried SnS particles may vary depending on the purity of the raw materials used, but the SnS purity measured by XRD is preferably 90% by mass or more, and more preferably 95% by mass to 100% by mass. This purity can be achieved by the production method described hereinbelow, which makes it possible to obtain a dispersion liquid having particles with more excellent dispersibility and desired properties. A method for determining the SnS purity by XRD measurement will be described in detail in the Examples. Here, “dried” means a state in which the moisture of the SnS particles taken out of the dispersion liquid has been removed and usually means a state in which the moisture content is 0.1% by mass or less. The moisture content can be measured using a conventional method without any particular restrictions. In addition, the drying method can be performed using a conventional method without any particular restrictions, and drying can be carried out under reduced pressure at 50° C. to 100° C. for 1 h to 10 h by using a vacuum dryer. In particular, SnS particles having an average major axis of preferably 100 nm to 500 nm, more preferably 100 nm to 200 nm, an average minor axis of preferably 50 nm to 200 nm, most preferably 50 nm to 150 nm, and an average aspect ratio (major axis/minor axis) of 1.2 to 1.6 are considered to have excellent dispersibility and to be useful as materials in various fields. Furthermore, it is particularly preferable that the average thickness be 100 nm to 300 nm, and the particle size distribution (based on scattering intensity, D50) be 200 nm to 500 nm. Such SnS particles can be obtained by extracting SnS particles from the SnS dispersion liquid obtained through an ultrasonic dispersion step in the production method described below, and drying the SnS particles as in the drying method described above. In that sense, when the method for producing a SnS dispersion liquid includes an ultrasonic dispersion step, the method for producing the SnS dispersion liquid can be said to correspond to a method for producing SnS particles.

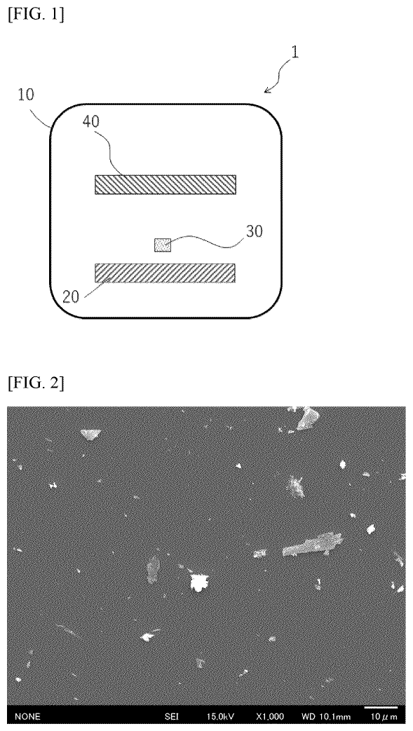

Furthermore, the SnS particles in the present invention may contain other particles. Examples of the other particles include acetylene black, carbon nanotubes, graphene, graphene oxide, graphite, silicon, silicon oxide, silicon carbide, and the like. The form “contained” here is inclusive of a state in which SnS particles and other particles are simply dispersed and mixed, as well as a state in which particles of each type aggregate and the respective aggregates further aggregate and a state in which particles of each type aggregate. In this case, the compounding ratio of the other particles is preferably 99 to 70 SnS: 1 to 30 other particles (weight ratio, total amount 100).

[Water-Based Dispersion Liquid] The water-based dispersion liquid used in the SnS dispersion liquid of the present invention can be water or a liquid mixture of water and a water-soluble organic solvent. The organic solvent can be an alcohol such as ethanol, isopropanol (IPA), and methanol, and the compounding ratio in this case is not particularly limited. [Alcohol-Based Dispersion Liquid] The alcohol-based dispersion liquid used in the SnS dispersion liquid of the present invention can use ethanol, isopropanol (IPA), methanol, and the like.

[SnS Dispersion Liquid] The concentration of the SnS particles (including the case where other particles are included) in the water-based dispersion liquid is preferably 0.0001% by mass to 50% by mass, more preferably 0.0001% by mass to 25% by mass, even more preferably 0.001% by mass to 20% by mass, and most preferably 0.01% by mass to 10% by mass. Where the concentration is below these ranges, it may be difficult to obtain the properties of the SnS particles. It is also preferable that the ranges be not exceeded because dispersibility may decrease, resulting in particle aggregation and a decrease in particle performance. The light absorbance of the dispersion liquid is preferably 0.15 or more at a wavelength of 600 nm, and preferably 0.1 or more at a wavelength of 1250 nm. The transmittance is preferably 70% or less at a wavelength of 600 nm. Furthermore, the mass absorption coefficient of the dispersion liquid (0.001% by mass) is preferably 15,000 cm⁻¹ or more, and more preferably 50,000 cm⁻¹ to 80,000 cm⁻¹, at a wavelength of 600 nm. The above light absorbance, transmittance, and mass absorption coefficient are all for an SnS particle concentration of 0.001% by mass, and it is preferable from the viewpoint of improving dispersibility that these properties be within the abovementioned ranges. The measurement methods are as described in the Examples. At an SnS particle concentration of 5% by mass, the light absorbance is preferably 1 or more at a wavelength of 600 nm, and preferably 0.8 or more at a wavelength of 1250 nm. The transmittance is preferably 5 or less at a wavelength of 600 nm. The mass absorption coefficient is preferably 25 cm⁻¹ or more, and more preferably 50 cm⁻¹ to 80 cm⁻¹.

<Method for Producing SnS Dispersion Liquid and Method for Producing SnS Particles> Next, methods for producing the SnS dispersion liquid and SnS particles of the present invention described above will be described. The method for producing SnS particles of the present invention can be carried out by performing a vapor deposition step of heating the SnS raw material contained in an evaporation source container to capture SnS in a capture container, and an isolation step of separating the obtained vapor deposition product from the capture container to obtain SnS particles. By this production method, the SnS particles constituting the SnS dispersion liquid of the present invention described above can be obtained, but the SnS particles that are particularly preferable among the SnS particles of the present invention described above can be obtained by carrying out method for producing the SnS dispersion liquid described below, then drying the obtained SnS dispersion liquid, and extracting (taking out) the SnS particles from the SnS dispersion liquid. Furthermore, the production method of the SnS dispersion liquid of the present invention is also a method for producing the SnS dispersion liquid of the present invention described above, and can be carried out by performing a vapor deposition step of heating the SnS raw material contained in an evaporation source container to capture SnS in a capture container, an isolation step of separating the obtained vapor deposition product from the capture container to obtain SnS particles, and a dispersion step of dispersing the vapor deposition product obtained in the isolation step in a water-based dispersion liquid. The vapor deposition step and the isolation step are common to the method for producing SnS particles and the method for producing a SnS dispersion liquid. In other words, it can be said that the method for producing a SnS dispersion liquid can be carried out by further including the dispersion step in the method for producing SnS particles. Therefore, the following explanation of the method for producing SnS particles also applies to the method for producing a SnS dispersion liquid.

[Raw Material] The SnS raw material used in the present invention is not particularly limited in purity as long as it is a bulk SnS raw material, but a raw material with a purity of 90% or more can be preferably used.

[Vapor Deposition Step] The vapor deposition step is a step of heating the SnS raw material contained in an evaporation source container and capturing SnS in a capture container and can be performed using the vapor deposition apparatus shown in FIG. 1. The vapor deposition apparatus 1 shown in FIG. 1 is equipped with a chamber 10 that can be sealed and evacuated, a heater 20 installed in the chamber 10, an evaporation source container 30, and a capture container 40. The evaporation source container 30 is configured to accommodate an evaporation source inside, and a thermometer (not shown) is installed in this evaporation source container 30 so that the temperature could be measured. The evaporation source container 30 can be heated by the heater 20. The capture container 40 is installed at a predetermined distance from the evaporation source container 30, and a thermometer (not shown) is installed so that the temperature could be measured. Any container that is normally used in this type of vapor deposition apparatus can be used, without any particular restrictions, as the heater, the evaporation source container, and the capture container. For example, the capture container may be made of glass, such as borosilicate glass, or metal, such as alumina, as long as it is heat-resistant and does not modify the SnS particles that are vapor-deposited. Although not shown in the figure, the chamber 10 is connected to a vacuum pump to reduce the pressure and to obtain a vacuum state and is also equipped with a valve for returning the reduced pressure state to a normal pressure state. As the thermometer, which is not shown in the figure, a usual thermocouple or the like may be used. There are no particular restrictions on the temperature measurement point, but it is preferable to measure the temperature near the side of the vapor deposition source container because this reduces the effect of the heater, and it is preferable to measure the temperature on the back side of the capture surface in the capture container for the same reason. In the vapor deposition step, the heating temperature of the evaporation source container 30 (the temperature measured by the thermometer) is 700° C. to 900° C., and the maximum capture container temperature of the capture container 40 (the maximum temperature among measured temperatures based on temperature anomaly) is 80° C. to 130° C. Where the abovementioned temperatures are outside these ranges, the SnS dispersion liquid of the present invention described above cannot be produced. The capture container 40 is installed at a predetermined distance from the evaporation source container 30. This distance is important in terms of adjusting the maximum capture container temperature of the capture container 40 and needs to be changed depending on the size of the chamber 10 and the amount of SnS raw material, but the maximum capture container temperature can be adjusted by adjusting this distance. In the vapor deposition step, it is preferable that the average capture rate be 20 mg/min or more in order to obtain a dispersion liquid of better quality. The vapor deposition step ends when the SnS raw material, which is the evaporation source, in the evaporation source container 30 runs out. It is preferable to maintain the pressure during the treatment at 5 Pa to 1×10⁻⁵ Pa.

[Isolation Step] The isolation step is a step of separating the obtained vapor deposition product from the capture container to obtain SnS particles. Specifically, this step can be performed by mechanically peeling and collecting the SnS particles in the capture container 40. This peeling and collection can be performed, without any particular restrictions, using any conventional method that can be used when producing particles by vapor deposition and isolating and recovering the produced particles. In addition, in this step, the SnS particles adhering to the capture container can also be isolated and recovered by repairing them in a volatile solvent such as ethanol. By obtaining an ethanol dispersion liquid in which the particles are thus dispersed, the loss of SnS particles due to scattering during collection can be reduced. In the case of simply mechanically peeling and collecting the SnS particles, the obtained SnS particles can be obtained as they are, and in the case of repairing the particles using a volatile solvent, the volatile solvent can be removed and the SnS particles can be dried to obtain SnS particles. In addition, a SnS dispersion liquid can be obtained by performing a dispersion step described hereinbelow.

[Dispersion Step] The dispersion step is necessary for carrying out the method for producing the SnS dispersion liquid of the present invention. In this step, the SnS particles obtained as a vapor deposition product in the isolation step are put into the water-based or alcohol-based dispersion liquid and the SnS particles are dispersed by a conventional method to obtain the SnS dispersion liquid of the present invention. In addition, in the dispersion step of the present invention, an ultrasonic dispersion step can be further carried out in which ultrasonic dispersion is performed preferably at an amplitude of 50 μm to 150 μm, more preferably 100 μm to 130 μm. The ultrasonic dispersion step can be performed using an ultrasonic device usually used for dispersion, such as an ultrasonic homogenizer, and the frequency can be freely selected and can be 20 Hz to 60 Hz. By performing the ultrasonic dispersion step with the amplitude in the abovementioned ranges, a SnS dispersion liquid with more excellent dispersibility can be obtained. Furthermore, when obtaining a SnS dispersion liquid containing the abovementioned other particles, the obtained SnS dispersion liquid can be mixed with other particles, such as acetylene black particles, and the abovementioned dispersion (ultrasonic dispersion step as necessary) can be further performed to obtain a SnS dispersion liquid containing other particles. In this case, the SnS particles obtained when the particles are extracted will be SnS particles containing the other particles.

[Other Steps] In the present invention, in addition to the abovementioned vapor deposition step, isolation step, and dispersion step, other steps can be performed without departing from the spirit of the present invention. For example, since the abovementioned SnS particles of the present invention are obtained by extracting (taking out) the SnS particles that constitute the SnS dispersion liquid, a drying step needs to be performed in which the SnS dispersion liquid is dried to obtain SnS particles. This drying step may vary in temperature and time depending on the amount of SnS particles to be dried, but can be carried out, for example, by drying at 50° C. to 100° C. under reduced pressure for 1 h to 10 h using a vacuum dryer.

### EXAMPLES

The present invention will be explained in more detail below with reference to Examples and Comparative Example, but the present invention is not limited to these.

### Example 1

The abovementioned vapor deposition step was performed using the vapor deposition apparatus shown in FIG. 1. A total of 13 g of bulk tin sulfide (with a purity of about 98%) was placed as a raw material in the vapor deposition source container 30. The distance between the vapor deposition source container 30 and the capture container 40 was set to 12.3 cm. Next, the inside of the chamber was evacuated to a pressure of 5×10⁻⁴ Pa range using a vacuum pump, and the temperature of the vapor deposition source container was raised to 900° C. using a heater, and the container was heated at 900° C. for 4 h. The maximum temperature of the capture container 40 was 101° C. The pressure during processing was 5×10⁻³ Pa to 1×10⁻⁴ Pa. The average capture rate measured by the abovementioned measurement method was 46.7 mg/min. Next, the isolation step and the dispersion step were performed.

First, the capture container 40 in the vacuum chamber 1 was removed, ethanol was poured into the capture container 40, and SnS (hereinafter also referred to as “tin sulfide”) was peeled off from the glass container to obtain a tin sulfide ethanol solution. The ethanol was removed from the obtained tin sulfide ethanol solution. The removal was performed as the isolation step by drying the tin sulfide ethanol solution under reduced pressure in a vacuum dryer (drying temperature 70° C., 4 h). Pure water was added to 0.4 g of the dried tin sulfide, and stirring was performed by a usual stirring method (stirring with a stirrer) to obtain 8 g of a 5% by mass tin sulfide aqueous solution (SnS dispersion liquid of the present invention). The SnS particles in the obtained dispersion liquid were dried to obtain SnS particles, and the following tests were performed using the obtained tin sulfide. A photograph of the particle shape is shown in FIG. 2, the XRD results in FIG. 7, and other results in Table 1.

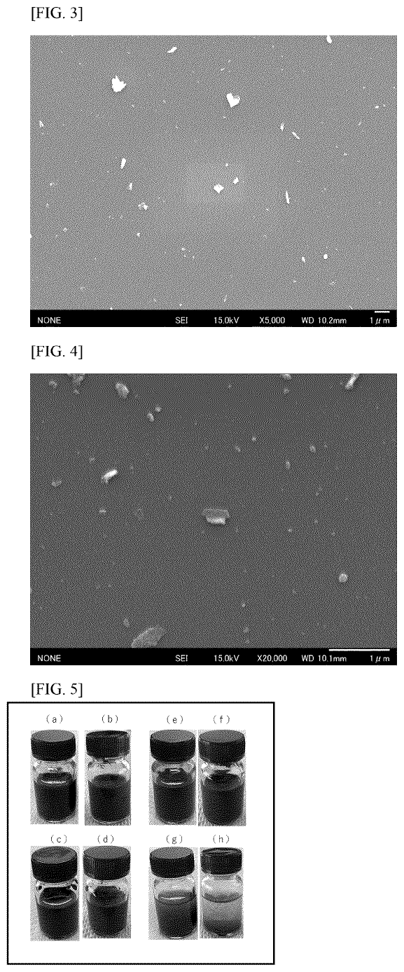

A precipitation test was conducted using the obtained SnS dispersion liquid. The storage container was thoroughly stirred by hand before the precipitation test was started. The precipitation test was conducted by checking the precipitation state at the start and after 17 h. The results are shown in FIGS. 3(a) and 3(b). The following measurements were also conducted using the obtained SnS dispersion liquid. The results are shown in Table 1. Particle size distribution measurement and zeta potential measurement: the solvent used was pure water, which was the same solvent as that of the SnS dispersion liquid, and the SnS dispersion liquid was diluted to 0.001% by mass to conduct the measurements. In addition, the obtained SnS dispersion liquid (concentration 5% by mass) was used for measurements as is. The particle size distribution measurement was conducted using particle size distribution measurement device “Litesizer (registered trademark) 500” manufactured by Anton Paar GmbH. The measurement method used was the dynamic light scattering method, the particle size distribution was measured based on the scattering intensity, and D10, D50, and D90 were calculated. After the particle size distribution measurement, the zeta potential measurement was also conducted using the same device. The pH at the time of measurement was 7. Absorbance and transmittance: the obtained SnS dispersion liquid (5% by mass) and the diluted solution obtained by diluting this dispersion liquid (5% by mass) with pure water to 0.001% by mass were used to perform measurements using a UV-Vis-Near-Infrared Spectrophotometer (product name “V770”) manufactured by JASCO Corporation. A quartz cell with an optical path length of 10 mm was used, and the mass absorption coefficient and transmittance were calculated using the Lambert-Beer law. The formula is shown below. Mass absorption coefficient (cm⁻¹)=absorbance/(tin sulfide mass fraction×optical path length of cell (cm)) transmittance (%)=10^{-(absorbance)}×100. The results are shown in Table 1. A small amount of the obtained SnS dispersion liquid was dropped onto a measurement substrate. This was heated at 70 degrees for 4 h under reduced pressure to remove moisture, and tin sulfide particles were obtained. FIG. 2 shows an image of tin sulfide particles taken with a field emission scanning electron microscope/transmission electron microscope “FE-SEM” (JSM-6500F, manufactured by JEOL Ltd.), and Table 1 shows the dimensions of the major axis A and minor axis B of the tin sulfide particles obtained from the image. Furthermore, the thickness L dimension was measured using a laser microscope (product name “KEYENCE VK-9700”, manufactured by Keyence Corporation,). A and B were obtained by visually detecting about 50 particles from the image and averaging the results. The SnS dispersion liquid was dried under reduced pressure in a vacuum dryer. The drying temperature was set to 70° C., and the drying time was about 4 h. After drying was completed, the tin sulfide (SnS) powder of the present invention was obtained. The obtained tin sulfide powder was used to identify the tin sulfide powder using an X-ray diffraction device “XRD” (product name “Empyrean”, manufactured by Malvern Panalystical Inc.). The measurement results are shown in FIG. 7. As a result, no peaks other than tin sulfide were detected, so the purity of tin sulfide was considered to be 99% by mass or more. Next, the specific surface area (specific surface area/pore distribution measuring device, product name “BELSORP-max”, manufactured by Microtrack Bell Co., Ltd.,) was measured using the BET measurement method. The results are shown in Table 1.

### Comparative Example

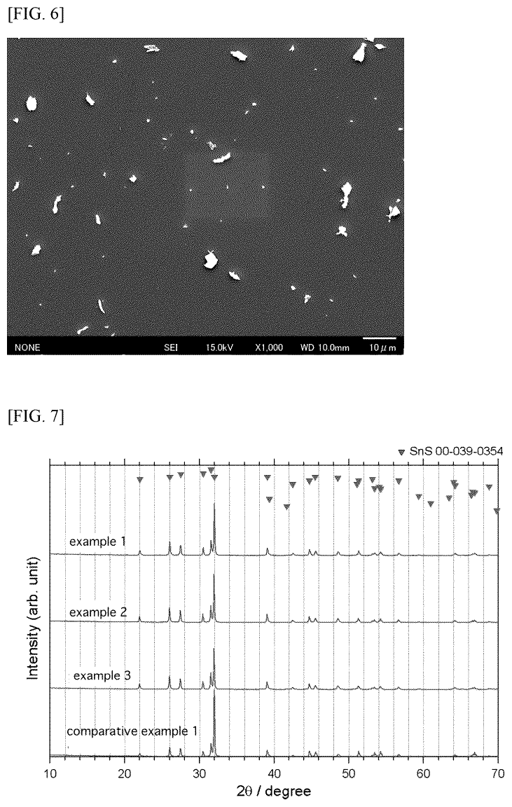

The amount of bulk tin sulfide (purity about 98%) was 1.7 g, the heating temperature was 900° C. for 3 h, and the distance between the capture container 40 and the vapor deposition source container 30 was 3.8 cm. Then, except that the maximum temperature of the capture container 40 was 199° C., the vapor deposition high ground was performed in the same manner as in Example 1. Furthermore, the dispersion step was performed in the same manner as in Example 1, and a SnS dispersion liquid was obtained. The obtained SnS particles and SnS dispersion liquid were subjected to the same tests and measurements as in Example 1. The results are shown in FIGS. 5, 6, and 7 and Table 1.

### Example 2

A SnS dispersion liquid was prepared and the tests and measurements were performed in the same manner as in Example 1, except that in the dispersion step, in addition to usual stirring, the following ultrasonic dispersion step was performed. In the ultrasonic dispersion step, the obtained 5% by mass SnS dispersion liquid was dispersed for 50 min at a frequency of 20 kHz and an amplitude of 60 μm by using an ultrasonic homogenizer (ultrasonic homogenizer, product name “Q125”, manufactured by QSONICA L.L.C). The results are shown in FIGS. 3, 5, and 7, and Table 1.

### Example 3

A SnS dispersion liquid was obtained in the same manner as in Example 2, except that the frequency was 20 KHz and the amplitude was 120 μm. The obtained SnS dispersion liquid was subjected to the tests and measurements in the same manner as in Example 1. The results are shown in FIGS. 4, 5, and 7, and Table 1.

TABLE 1

| | the | | | | | | | | |
|---|---|---|---|---|---|---|---|---|---|
| the vapor | maximum | the | | the | particle size n = 50 | | | | the particle size |
| deposition | capture | average | the | ultrasonic | the | the | | thick- | distribution based on |
| source | container | capture | ultrasonic | exposure | major | minor | AB | ness | the scattering intensity |

| | temperachar | temperature | rate | amplitude | time | axis A | axis B | ratio | L | D10 | D50 |
|---|---|---|---|---|---|---|---|---|---|---|---|
| | (° C.) | (° C.) | (mg/min) | (μm) | (min) | (nm) | (nm) | A/B | (nm) | (nm) | (nm) |
| example1 | 700~900 | 101 | 46.7 | — | — | 1425.5 | 774.3 | 1.57 | 524 | 167.2 | 570.1 |
| example2 | | | | 60 | 50 | 272.9 | 179.3 | 1.58 | 201 | 112.9 | 264 |
| example3 | | | | 120 | 50 | 143 | 103.8 | 1.38 | 148 | 123 | 248 |
| comparative | | 199 | 10.4 | — | — | 2577.1 | 1567.5 | 1.65 | 1356 | 566 | 1503.9 |
| example | | | | | | | | | | | |

| | | | | | | The above | | | The above |
|---|---|---|---|---|---|---|---|---|---|
| | | | | | | light | | | light |
| | | | | The above light | | absorbance | The above light | | absorbance |
| | the particle size | | | absorbance | | ratio | absorbance | | ratio |
| | distribution based on | | | concentration5% | | concentration5% | concentration | | concentration |
| | the scattering intensity | | Zeta | tha | tha | tha | 0.001% | | 0.001% |
| | | (D90 − | potential | wave- | wave- | wavelength | tha | tha | tha |
| | D90 | D10)/ | PH = 7 | length | length | 600 nm/ | wavelength | wavelength | wavelength |
| | (nm) | D50 | (mV) | 600 nm | 1250 nm | 1250 nm | 600 nm | 1250 nm | 600 nm/1250 nm |
| example1 | 1154.3 | 1.73 | −42.0 | 1.308 | 0.912 | 1.435 | 0.161 | 0.121 | 1.325 |
| example2 | 931.4 | 3.10 | −49.0 | 2.792 | 2.352 | 1.187 | 0.578 | 0.429 | 1.346 |
| example3 | 543.2 | 1.69 | −44.1 | 3.432 | 2.705 | 1.268 | 0.789 | 0.523 | 1.510 |
| comparative | 4073.9 | 2.33 | −45.0 | 0.96 | 0.537 | 1.788 | 0.147 | 0.075 | 1.955 |
| example | | | | | | | | | |

| | | | | mass | | | |
|---|---|---|---|---|---|---|---|
| | transmittance | transmittance | mass | absorption | | | |
| | concentration | concentration | absorption | coefficient | | | |
| | 5% | 0.001% | coefficient | concentration | | | |
| | (%) | (%) | concentration5% | 0.001% | specific | | |
| | tha | tha | (cm⁻¹) | (cm⁻¹) | surface | the precipitation test | |
| | wavelength | wavelength | wavelength | wavelength | area | concentration5% | |
| | 600 nm | 600 nm | 600 nm | 600 nm | (m²/g) | 0 h | 17 h |
| example1 | 4.92 | 69.08 | 26.2 | 16063.1 | 7.5 | no | no |
| | | | | | | precipitation | precipitation |
| example2 | 0.16 | 26.43 | 55.8 | 57790.3 | 10.0 | no | no |
| | | | | | | precipitation | precipitation |
| example3 | 0.04 | 16.25 | 68.6 | 78919.6 | 11.0 | no | no |
| | | | | | | precipitation | precipitation |
| comparative | 10.96 | 71.22 | 19.2 | 14739.7 | 2.3 | no | precipitation |
| example | | | | | | precipitation | |

In Table 1, “%” indicates “% by mass”.

As is clear from the results shown in FIG. 5, the SnS dispersion liquid of the present invention has excellent dispersibility, with no precipitation occurring even after 17 h. Meanwhile, the dispersion liquid of Comparative Example has poor dispersibility, with precipitation occurring with the passage of time. Therefore, the SnS particles of the present invention have such excellent dispersibility and are considered to be able to exhibit excellent characteristics in various applications.

### Example 4

Pure water was added to 0.8 g of dried tin sulfide obtained in the same manner as in Example 1, and stirring was performed by a normal stirring method (stirring with a stirrer) to prepare 8 g of a 10% by mass tin sulfide aqueous solution (SnS dispersion liquid).

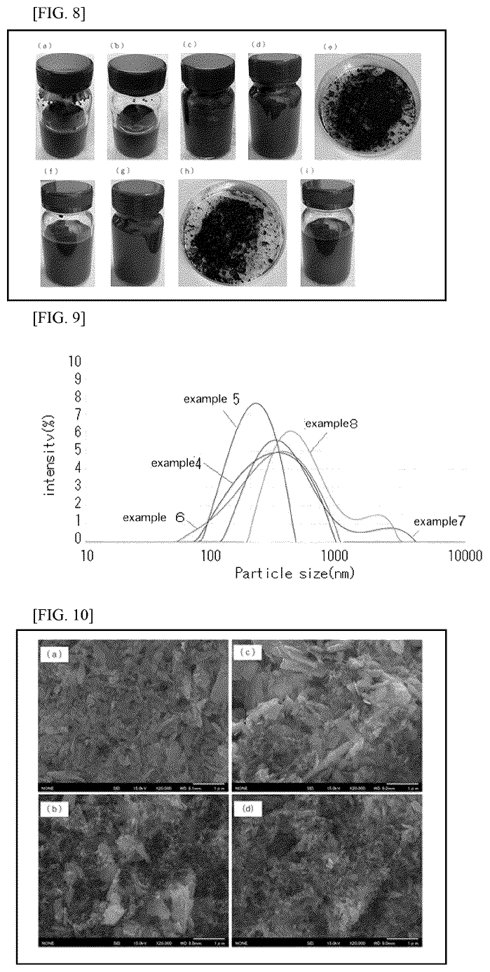

The SnS dispersion liquid obtained was dispersed for 90 min using an ultrasonic homogenizer (ultrasonic homogenizer, product name “Q125”, manufactured by QSONICA L.L.C) at a frequency of 20 kHz and an amplitude of 120 μm to obtain the SnS dispersion liquid of the present invention (the obtained dispersion liquid is shown in FIG. 8(a)).

The obtained SnS dispersion liquid was used to measure the particle size distribution. The solvent used was pure water, which is the same solvent as in the SnS dispersion liquid, and the SnS dispersion liquid was diluted to 0.001% by mass for measurement. The particle size distribution was measured using particle size distribution measurement device “Litesizer (registered trademark) 500” manufactured by Anton Paar GmbH. The measurement method used was dynamic light scattering, the particle size distribution was measured based on the scattering intensity, and D10, D50, and D90 were calculated. The results obtained are shown in Table 2 and FIG. 9.

### Example 5

Pure water was added to 1.6 g of dried tin sulfide obtained in the same manner as in Example 1, and stirring was performed by a usual stirring method (stirring with a stirrer) to prepare 8 g of a 20% by mass tin sulfide aqueous solution (SnS dispersion liquid).

Using an ultrasonic homogenizer (ultrasonic homogenizer, product name “Q125”, manufactured by QSONICA L.L.C), the obtained SnS dispersion liquid was dispersed for 90 min at a frequency of 20 kHz and an amplitude of 120 μm to obtain the SnS dispersion liquid of the present invention (the obtained dispersion liquid is shown in FIG. 8(b)).

The obtained SnS dispersion liquid was used to measure the particle size distribution. The solvent used was pure water, which is the same solvent as in the SnS dispersion liquid, and the SnS dispersion liquid was diluted to 0.001% by mass for measurement. The particle size distribution was measured using particle size distribution measurement device “Litesizer (registered trademark) 500” manufactured by Anton Paar GmbH. The measurement method used was dynamic light scattering, the particle size distribution was measured based on the scattering intensity, and D10, D50, and D90 were calculated. The results obtained are shown in Table 2 and FIG. 9.

### Example 6

Isopropyl alcohol (special grade 2-propanol, manufactured by Kanto Chemical Co., Ltd.) was added to 1.6 g of dried tin sulfide obtained in the same manner as in Example 1, and stirring was performed by a usual stirring method (stirring with a stirrer) to prepare 8 g of a 20% by mass tin sulfide isopropyl alcohol solution (SnS-IPA dispersion liquid obtained by dispersing SnS in IPA).

The obtained SnS-IPA dispersion liquid was dispersed for 90 min using an ultrasonic homogenizer (ultrasonic homogenizer, product name “Q125”, manufactured by QSONICA L.L.C) at a frequency of 20 kHz and an amplitude of 120 μm to obtain the SnS dispersion liquid of the present invention. The obtained dispersion liquid is shown in FIG. 8(c).

The obtained SnS-IPA dispersion liquid was used to measure the particle size distribution. The solvent used was isopropyl alcohol, which is the same solvent as in the SnS-IPA dispersion liquid, and the SnS-IPA dispersion liquid was diluted to 0.001% by mass for measurement. The particle size distribution was measured using particle size distribution measurement device “Litesizer (registered trademark) 500” manufactured by Anton Paar GmbH. The measurement method used was dynamic light scattering, the particle size distribution was measured based on the scattering intensity, and D10, D50, and D90 were calculated. The results obtained are shown in Table 2 and FIG. 9.

### Example 7

The same operations as in Example 6 were performed to obtain a 20% by mass SnS-IPA dispersion liquid.

Separately, acetylene black (DENKA BLACK Li Li-100 powder product, manufactured by Denka Co., Ltd., average particle size: 35 nm, specific surface area: 68 m²/g, bulk density: 0.04 g/ml) was prepared. This acetylene black was added to the 20% by mass SnS-IPA dispersion liquid so that the ratio of tin sulfide to acetylene black was 95:5, and dispersion and mixing were carried out for 1 h using ultrasonic waves (Ultrasonic cleaner ASU-2, manufactured by As One Co., Ltd., oscillator circuit: separate excitation type, high frequency output: 40 W, oscillation frequency: 42 kHz) to prepare a tin sulfide-acetylene black mixed dispersion liquid (SnS dispersion liquid of the present invention, SnS and acetylene black concentration: 20.8% by mass). The obtained results are shown in FIG. 8(d).

The obtained tin sulfide-acetylene black mixed dispersion liquid was heated at 70 degrees for 4 h under reduced pressure to remove moisture, and tin sulfide-acetylene black mixed particles were obtained. The obtained particles are shown in FIG. 8(e).

FIG. 10(a) shows an image of tin sulfide particles taken with a field emission scanning electron microscope/transmission electron microscope “FE-SEM” (JSM-6500F, manufactured by JEOL Ltd., hereafter referred to as SEM). In addition, the tin sulfide-acetylene black mixed dispersion liquid was diluted to 0.01% by mass, dried in the same manner, and photographed using SEM to confirm the dispersion state of acetylene. The results are shown in FIG. 10(b).

Furthermore, the obtained tin sulfide-acetylene black mixed particles were used to measure the particle size distribution. A total of 0.1 g of tin sulfide-acetylene black mixed particles was used and pure water was added to manufacture a 0.01% by mass aqueous dispersion liquid, which was then measured. The particle size distribution was measured using particle size distribution measurement device “Litesizer (registered trademark) 500” manufactured by Anton Paar GmbH. The measurement method used was dynamic light scattering, the particle size distribution was measured based on the scattering intensity, and D10, D50, and D90 were calculated. The results obtained are shown in Table 2 and FIG. 9.

A total of 0.5 g of tin sulfide-acetylene black mixed particles was used, pure water was added and stirring was performed using a usual stirring method (stirring with a stirrer), to manufacture a 1% by mass tin sulfide-acetylene black mixed aqueous dispersion liquid, and the dispersion state in the pure water was confirmed. The results are shown in FIG. 8(f).

### Example 8

The same operations as in Example 6 were performed to obtain a 20% by mass SnS-IPA dispersion liquid.

Acetylene black was added to the 20% by mass SnS-IPA dispersion liquid so that the ratio of tin sulfide to acetylene black was 90:10, and dispersion and mixing were carried out for 1 h using ultrasonic waves to prepare a tin sulfide-acetylene black mixed dispersion liquid (SnS dispersion liquid of the present invention, SnS and acetylene black concentration: 21.7% by mass). The obtained dispersion liquid is shown in FIG. 8(g).

Tin sulfide-acetylene black mixed particles were obtained in the same manner as in Example 7. The obtained particles are shown in FIG. 8(h). In addition, an image of the tin sulfide-acetylene black mixed particles taken with an FE-SEM is shown in FIG. 10(c). The tin sulfide-acetylene black mixed dispersion liquid was diluted to 0.01% by mass, dried in the same manner, and photographed with an SEM to confirm the dispersion state of acetylene. The results are shown in FIG. 10(d).

The particle size distribution was measured in the same manner as in Example 7. The results are shown in Table 2 and FIG. 9.

A total of 0.5 g of tin sulfide-acetylene black mixed particles were used, pure water was added and stirring was performed by a usual stirring method (stirring with a stirrer) to manufacture a 1% by mass tin sulfide-acetylene black mixed aqueous dispersion liquid, and the dispersion state in pure water was confirmed. The results are shown in FIG. 8(i).

TABLE 2

| | the | the | | | | | |
|---|---|---|---|---|---|---|---|
| | vapor | maximum | | the | | the | |
| | deposition | capture | the | average | the | ultrasonic | |
| | source | container | capture | capture | ultrasonic | exposure | |
| | temperachar | temperature | container | rate | amplitude | time | |
| | (° C.) | (° C.) | materia | (mg/min) | μm | (min) | solvent |
| example4 | 700~900 | 101 | soda | 46.7 | 120 | 90 | water |
| example5 | | | glass | | | | |
| example6 | | | | | | | IPA |
| example7 | | | | | | | |
| example8 | | | | | | | |

| | | | | | the particle size distribution | | | |
|---|---|---|---|---|---|---|---|---|
| | | | mixture ratio | | based on the scattering intensity(nm) | | | |
| | | | | acetylene | | | | (D90 − |
| | concentration | | SnSb | black | | | | D10)/ |
| | (%) | form | ratio | ratio | D10 | D50 | D90 | D50 |
| example4 | 10 | dispersion | 100 | 0 | 108.8 | 241.7 | 498.1 | 1.61 |
| example5 | 20 | liquid | | | 119.3 | 201.8 | 323.9 | 1.01 |
| example6 | | | | | 124.0 | 303.6 | 627.6 | 1.66 |
| example7 | | particles | 95 | 5 | 183.0 | 350.3 | 988.9 | 1.69 |
| example8 | | | 90 | 10 | 266.1 | 476.5 | 1462.5 | 2.51 |

In Table 2, “%” indicates “% by mass.”

1. A SnS dispersion liquid in which SnS particles are dispersed in a water-based or alcohol-based dispersion liquid, wherein an average major axis of the dispersed SnS particles is 100 nm to 2000 nm, an average minor axis of the SnS particles is 50 nm to 1000 nm, and an average aspect ratio (major axis/minor axis) is 1.2 to 1.6.

2. The SnS dispersion liquid according to claim 1, wherein a concentration of the SnS particles in the water-based dispersion liquid is 0.0001% by mass to 50% by mass.

3. The SnS dispersion liquid according to claim 1, wherein an average thickness of the SnS particles is 100 nm to 1000 nm, and a particle size distribution (based on scattering intensity, D50) of the SnS particles is in the range of 100 nm to 700 nm.

4. The SnS dispersion liquid according to claim 1, wherein a SnS purity as measured by XRD of dried SnS particles is 90% by mass or more.

5. The SnS dispersion liquid according to claim 1, wherein a specific surface area of the SnS particles is 5 m²/g or more as measured by a BET measurement method.

6. The SnS dispersion liquid according to claim 1, wherein a mass absorption coefficient (0.001% by mass) is 15,000 cm⁻¹ or more at a wavelength of 600 nm.

7. SnS particles extracted from the SnS dispersion liquid according to claim 1, wherein an average major axis of the SnS particles is 100 nm to 2000 nm, an average minor axis of the SnS particles is 50 nm to 1000 nm, and an average aspect ratio (major axis/minor axis) is 1.2 to 1.6.

8. The SnS particles according to claim 7, wherein an average thickness of the SnS particles is 100 nm to 1,000 nm, and a particle size distribution (based on scattering intensity, D50) of the SnS particles is in the range of 100 nm to 700 nm.

9. The SnS particles according to claim 7, wherein a SnS purity as measured by XRD of dried SnS particles is 90% by mass or more.

10. The SnS particles according to claim 7, wherein a specific surface area of the SnS particles is 5 m²/g or more as measured by a BET measurement method.

11. The SnS particles according to claim 7, wherein the SnS particles are SnS or mixed particles of SnS and acetylene black.

12. A method for producing SnS particles, including: a vapor deposition step of heating a SnS raw material contained in an evaporation source container to capture SnS in a capture container, and an isolation step of separating the obtained vapor deposition product from the capture container to obtain SnS particles, wherein in the vapor deposition step, a heating temperature of the evaporation source container is 700° C. to 900° C. and a maximum capture container temperature of the capture container is 80° C. to 130° C.

13. The method for producing SnS particles according to claim 12, wherein an average capture rate in the vapor deposition step is 20 mg/min or more.

14. A method for producing the SnS dispersion liquid according to claim 1, including: a vapor deposition step of heating a SnS raw material contained in an evaporation source container to capture SnS in a capture container, an isolation step of separating the obtained vapor deposition product from the capture container to obtain SnS particles, and a dispersion step of dispersing the vapor deposition product obtained in the isolation step in a water-based or alcohol-based dispersion liquid, wherein in the vapor deposition step, a heating temperature of the evaporation source container is 700° C. to 900° C. and a maximum capture container temperature of the capture container is 80° C. to 130° C.

15. The method for producing the SnS dispersion liquid according to claim 14, wherein the dispersion step includes an ultrasonic dispersion step of performing ultrasonic dispersion with an amplitude of 50 μm to 150 μm.
